(19) United States
(12) Patent Application Publication
(10) Pub. No.: US 2018/0096420 A1
(43) Pub. Date: Apr. 5, 2018

(54) Enhanced Bidding System

(71) Applicant: Aiooki Limited, Grand Cayman (KY)

(72) Inventors: Lam Sun, Foster City, CA (US); Boxiong Ding, San Jose, CA (US); Kuan-Cheng Lai, Santa Clara, CA (US)

(21) Appl. No.: 15/472,247

(22) Filed: Mar. 28, 2017

Related U.S. Application Data
(60) Provisional application No. 62/404,714, filed on Oct. 5, 2016.

(51) Int. Cl. G06Q 30/08

(52) U.S. Cl. CPC G06Q 30/08

(57) ABSTRACT

Some embodiments provide a bidding system configured to estimate a bid for a new item. In some implementations, the bidding system can be configured to build a statistics model for predicting a price difference between the listed price of an item and sold price of the same item. In some embodiments, the bidding system can be configured to train a classification model using extracted features. The prediction can be based on sales information regarding one or more items that were previously sold. In some implementations, building such a statistics model may include extracting features from structured data and as well as unstructured data regarding those previously sold items. Structured data may include one or more classifications of the items that are readily available in a classification system or classification systems. Unstructured data may include text description about those items.

### CROSS-REFERENCE TO RELATED APPLICATIONS

The present application claims priority to U.S. Provisional Patent Application No. 62/404,714, filed on Oct. 5, 2016 and entitled “ENHANCED USER MATCHING, RECOMMENDATION AND PREDICATION SYSTEMS”, the disclosures of which is hereby incorporated by reference in their entireties for all purposes.

### BACKGROUND OF THE INVENTION

The disclosure relates to user matching and generating recommendation for users using a computer system.

User matching is generally known in the art. Existing user matching technologies typically match users based on their preferences or certain user characteristics. For example, two users may be matched simply based on their geographical locations. Under the existing user matching technologies, the user matching may be refined until an acceptable result is obtained. For example, the conventional matching technologies may first start with a big group of users that can be matched based on their generally geographical regions (e.g., their current countries), and fine-tuned to match their finer locations as desired (e.g., their current cities).

Recommendation systems are generally known in the art. Existing recommendation systems typically recommend an entity (e.g., a website) to a user based on a relationship between the recommended entity and the user's interest. For example, some of the existing recommendation systems are configured to collect data regarding user browsing activities and analyze such data to learn the user's interest. These systems are also configured to determine a likelihood the user will visit the website based on the learned user interest and select a website for recommendation to the user based on the determined likelihood the user will visit the website.

Bidding systems are generally in the art. Existing bidding systems are typically configured to receive user bids for a certain item. A given user bid that is received by the existing bidding systems typically a user determined price and an identification of the given item. The existing bidding systems are typically configured to compare all received user bids to determine a winning bid.

### BRIEF SUMMARY OF THE INVENTION

Some embodiments provide a bidding system configured to estimate a bid for a new item that will increase a likelihood that the user will win the new item without having to over-bid. In some exemplary implementations, the bidding system in accordance with the disclosure can be configured to build a statistics model for predicting a price difference between the listed price of an item and sold price of the same item. The prediction can be based on sales information regarding one or more items that were previously sold. In some implementations, building such a statistics model by the bidding system in accordance with the disclosure may include extracting features from structured data and as well as unstructured data regarding those previously sold items. Structured data may include one or more classifications of the items that are readily available in a classification system or classification systems. Unstructured data may include text description about those items.

In some implementations, the bidding system may be configured to process the unstructured data to extract features regarding the previously sold items and combine those features with features extracted from structured data. In some implementations, the system may be further configured to employ machine-learning model such as a regression model, a Random Forest or Support Vector Machine to build the statistic model. Using the statistic model, the bidding system can be configured to predict a bid price for the new item. In some embodiments, the bidding system can be used to provide suggested bid price for users to use for real-estate properties.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

FIG. 1 illustrates an example of both structured data and unstructured data.

FIG. 2 illustrates a bidding system in accordance with the disclosure can be configured with text mining or feature engineering capability to process unstructured data.

FIG. 3 illustrates a regression model can trained using the extracted features after features are extracted from the structured data and unstructured data for a set of items in the same category as the target item.

FIG. 4 illustrates a classification model can be trained by the feature data and price data mentioned above to predict DOM for a property.

FIG. 5 illustrates an example of a prediction matching system in accordance with the disclosure.

FIG. 6 illustrates an exemplary method for predicting a price for suggestion to a user for bidding for a target item in accordance with the disclosure.

FIG. 7 is a block diagram of computer system that can be used to implement various embodiments described and illustrated herein.

### DETAILED DESCRIPTION OF THE INVENTION

Embodiments can provide a bidding system configured to predict a price of an item on sale (herein “target item”) for suggestion to a user and to enable the user to bid for the item based on the predicted price. The predicted price by the bidding system may represent an estimation by the bidding system that the item will be likely sold at the predicted price. Examples of the predicted price may include a price an investment property such as real-estate property, stock, commodity, for an auction item sold on a second-hand market (e.g., eBay), and/or any other item with a negotiable price. For achieving this, historical sales data about a set of items relevant to the target item can be collected by the bidding system. The sales data may include information regarding a set of features for those items. The sales data can be processed by the bidding system to extract those features from each item in the set. The sales data may also include information indicating price differences between their listing prices and final sales prices in the past sales transactions.

In some implementations, the bidding system can be configured to train a regression model using the extracted features and the afore-mentioned listing-sales price differences for those items. The regression model can be used by the bidding system to predict a listing-sales price difference for the target item based on features possessed by the target item. In some embodiments, the bidding system can be configured to train a classification model using extracted features for the items in the set. In those embodiments, the classification model can be used by the bidding system to predict days on the market (DOM) for the target item based on the features possessed by the target item.

In some examples, the sales data for the items may include structured data and unstructured data. As used herein, structured data may be referred to as data readily indicating one or more features about the items. For example, when the target item is a real-estate property such as a house, the set of items may be houses sold within past a few months in the same area as where the target house is located. In that example, the structured data for a given house in that set may include last price sold, DOM before last sold, a number of bedrooms, bathrooms, living room, lot size, year built, and any other structured data that can be readily obtained from a real-estate listing webpage for the given house.

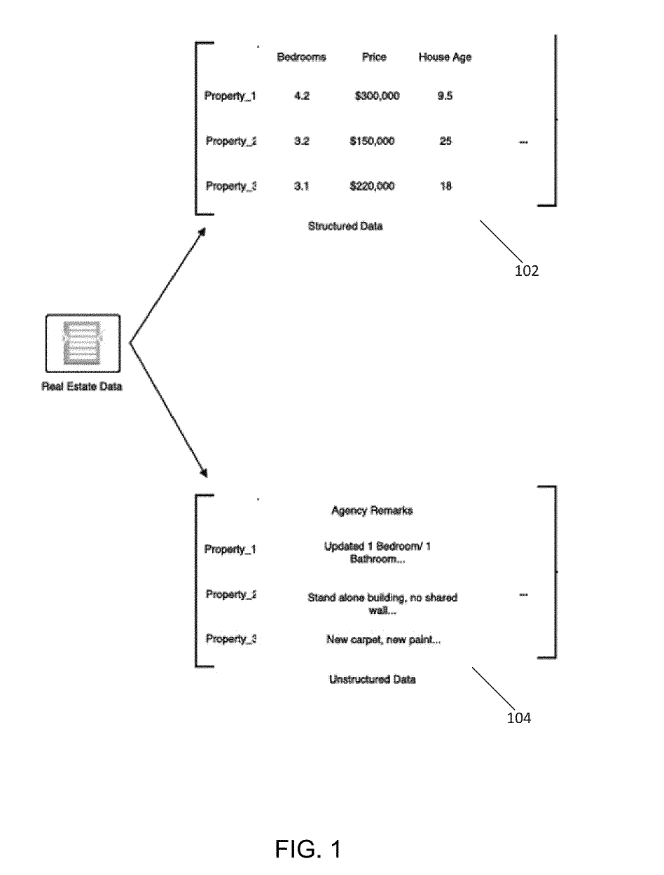

As used herein, unstructured data may be referred to as data not readily indicating one or more features about the items. As such, unstructured data may need further processing. One example of unstructured data may include agency data for the houses in the set mentioned above. The agency data may include text description about those houses such as their directions, level of remodeling done, materials used for the remodeling, agent remarks, and/or any other unstructured data about the houses. Typically, the agency data for a given house is listed at the bottom of a webpage listing the given house. Another example of unstructured data may include various user comments about the given house. The user comment data may include information regarding impressions by users that have seen the houses or known the houses. The user comment data may also include information regarding conditions about the houses. An example of both structured data and unstructured data for houses in the set is illustrated in FIG. 1.

As shown in FIG. 1, real-estate data provided from a source, such as a listing web page, or a database may include structured data 102 by which various aspects about a given real-estate property can be readily known, such as the number of bedrooms, the listing price, the age of the given real-estate property, and/or any other aspects. As also shown, the real-estate data may include unstructured data 106, such as text description about the given real-estate property, for example by real-estate agents or people that are interested in the given real-estate property. As shown, structured data 102 and unstructured data 104 can be obtained for multiple real-estate properties that are in the same category as the target property. For example, properties 1-3 shown in FIG. 1 may be real-estate properties within 5 miles radius from the target property. However, this is only illustrative. One skilled in the art will understand how to categorize real-estate properties using various filters other than geographical area.

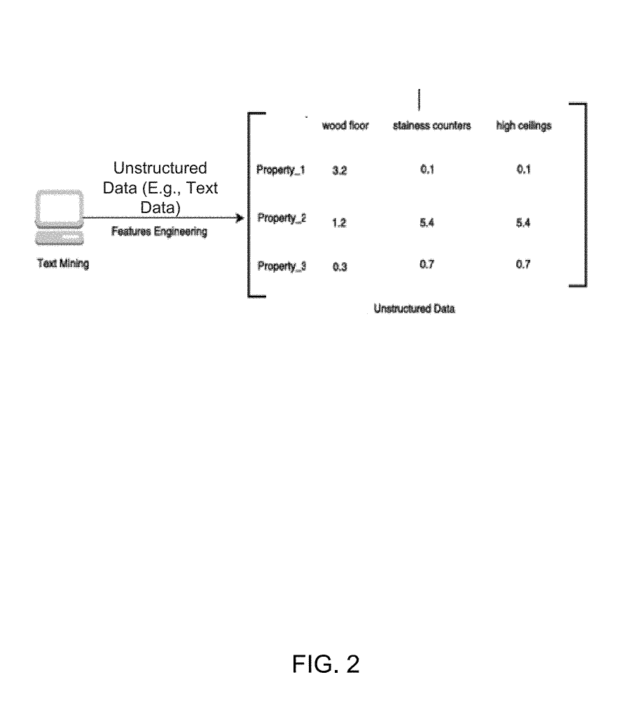

In any case, the unstructured data 104 needs processing in order for the data to be usable by the bidding system. In some implementations, the bidding system in accordance with the disclosure can be configured with text mining or feature engineering capability to process the unstructured data 104. This is illustrated in FIG. 2. In some exemplary implementations, the text mining that can be performed by the bidding system may involve removing one or more stop words such as “is”, “the” and “as' which don't have distinguishing power in the agency data. The text mining may also include generation of nGrams terms that can capture important word like “remodeled”, “repainted” or word chunks like “recent paint”.

By way of example, as illustration, unstructured data 104 for the given real-estate property may include following texts: “Updated 1 Bedroom/1 Bathroom condo featuring recent appliances, laminate flooring and recent paint. Community amenities put this condo ahead of the competition with tennis court, lounge areas, outdoor inground pool/hot tub and gym. 1 covered RSVP spot convey with the unit. No assessments are due. Washer, Dryer, Refrigerator and Microwave convey. Please call Bridget/agent 5122935212 to give the tenant 30 min notice. Lease ends Mar. 31, 2016. Tenant will stay if investor. Current rent is $935.” In this exemplary text description, hidden features about the property such as “updated”, “recent appliances”, “laminate flooring” and “recent paint” may be mined.

In implementations, the text mining performed by the bidding system can include finding the terms that may affect the final sales price of the real-estate property. The text mining by the bidding system can also include quantifying those terms, i.e., the number of times each of those terms appear in the text description in the unstructured data 104. In one implementation, frequency—inverse document frequency (TDIDF) is used for achieving this. TDIDF essentially can reflect how important the term may be to a corresponding real-estate property by comparing the frequency of this term to this property with the one to other properties.

In one exemplary implementation, Python NLTK library is used for the bidding system in accordance with the disclosure to extract the unstructured features in a Natural Language Process. In that implementation, all the agency remarks are first joined as a corpus. And then each word of the corpus is tokenized and stop words and punctuations are deleted at the same time. Stemmer is also used in that implementation to help find the stem of each token and to prevent missing those terms with different format which should be counted together like garage and garages. After cleaning up those words, bigram and trigram can be applied in order to track down those popular terms like natural light and “cul-de-sac”. As a result, candidate terms after text mining can be obtained. In that implementation, the candidate terms are further examined by a human expert that has knowledge about real-estate investment to further determine which of these candidate terms can be used as features for price difference predictions. For example, house condition is typically a feature that can affect the price difference and thus is used as a feature. Another candidate term that can be used as a feature is how many offers that the property has received.

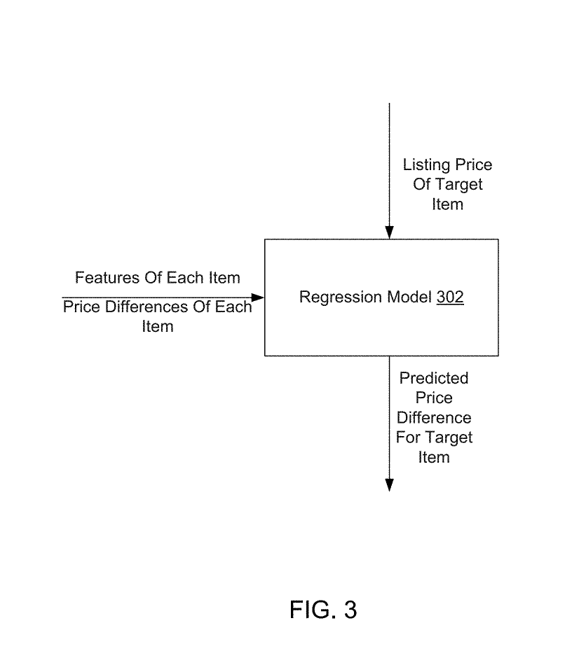

After values for various features are extracted from the structured data 102 and unstructured data 104 for the set of items in the same category as the target item, a regression model can be trained using the extracted features. FIG. 3 illustrates this. As shown, the regression model 302 can be trained using the features extracted from the set of items. In some implementations, the regression model 302 can include a random forest and/or a boosting tree. For each item in the set, from the extracted features, the list price and actual sold price may be known, and thus the price difference for the item may also be known. Using the feature engineering described above, one or more features associated with the item can also be known. Using these data, the regression model 302 can be trained to predict a price that can be suggested to a user for bidding for the target item.

As illustration, the target item may be a house newly listed, and the set of items may include all houses that were sold in the same area where the target house is located within the last 3 months. After the feature engineering described above, features for each house in the set are obtained and a price difference for the house is also obtained. For example, house 1 in the set may have the following features: 3 bed rooms, 2.5 bath rooms, 2 living rooms, 1800 square feet, 4000 square feet lot size, 2 car attached garage, 2 floors, wood floor, good condition, upgraded kitchen, and other features. House 1 was sold 2 months ago with a listing price of $650,000 and was sold at $620,000, the price difference for house 1 is $30,000. Similar data can be obtained for other houses in the set. These data can be used to train the regression model 302.

After the regression model 302 is trained, as shown in FIG. 3, a price difference can be predicted for the target item, e.g., the target house described above. That is, the listing price of the target house can be fed into the regression model 302 and a predicted price difference can be determined by the regression model 302 based on the listing price of the target house. The predicted price difference can be a positive or negative value and can be combined with the listing price to obtain a suggested bidding price to a user for bidding for the target house. For example, a price difference of $−30,000 can be determined for the target house based on the listing price of $650,000. In that example, the suggested price for a user to bid for the target house can be $620,000. In some implementations, the predicted price difference may be in the form of price per square foot. For example, a price difference of +$4/sq ft can be predicted such that a user should consider add $4 per square foot for the bidding price when bid for the target house.

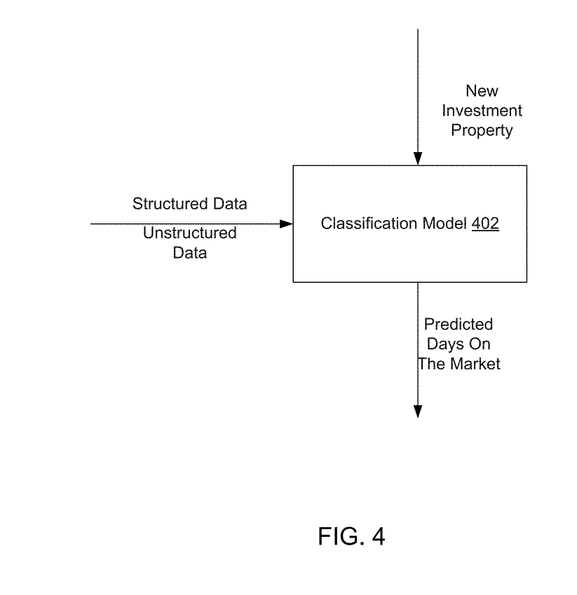

In some embodiments, a classification model can be trained by the feature data and price data mentioned above to predict DOM for a property. This is illustrated in FIG. 4. In some implementations, the classification model 402 can include a logic regression model, a random forest, a support vector machine and/or any other suitable classification model. Similarly, the classification model 402 can be trained using the feature data about the set of items in the same category as the target item. During the prediction stage, a new property can be fed into the classification model 402 to predict DOM for the new property or whether or not the new property would be sold within a certain period of time, e.g., a week.

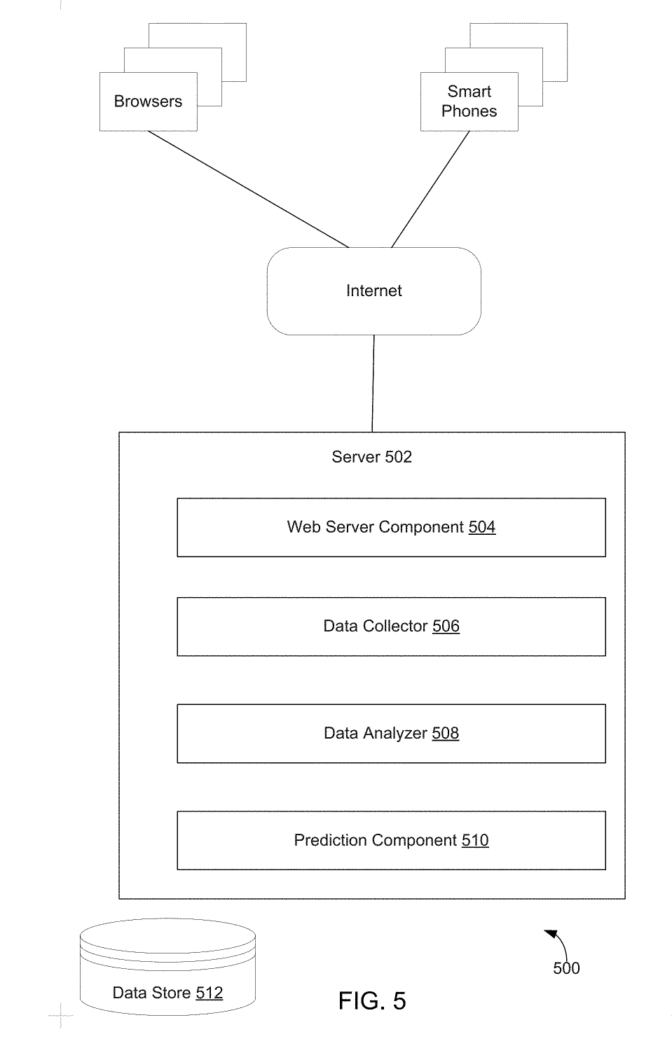

With various working principles of the bidding system having been generally described above, attention is now directed to FIG. 5 where an example of bidding system 500 in accordance with the disclosure is illustrated. As shown, the bidding system 500 can include a server 502. The server 502 can include one or more computer components including a web server component 504, a data collector 506, a data analyzer 508, a prediction component 510, and/or any other components.

The web server component 504 can be configured to receive, via an internet, data requests from user applications such as browsers and apps as shown. The web server component 504 can be configured serve web pages to the user applications. In some embodiments, the web server component 504 can be configured to receive user data, such as user answers to questionnaire posted on one or more pages served by the web server component 504.

The data collector 506 can be configured to collect various data as described and illustrated herein. The data collected by the data collector 502 can include the structured data and the unstructured data for a set of items such as real-estate properties as described and illustrated in FIGS. 1-2.

The data analyzer 508 can be configured to perform the regression model training and the classification model training as described and illustrated in FIGS. 3 and 4.

The prediction component 510 can be configured to predict a price difference for a given target item using the regression model trained by the data analyzer 508 and generate a bidding price for suggestion to a user based on the predicted price difference. In some embodiments, the prediction component 510 can be configured to predict DOM for a new property based on classification model trained by the data analyzer 508.

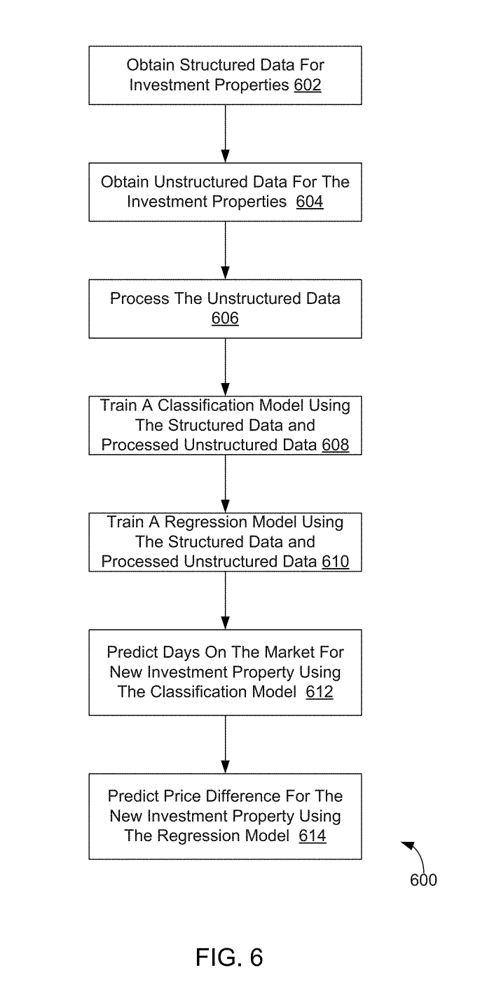

FIG. 6 illustrates an exemplary method for predicting a price for suggestion to a user for bidding for a target item in accordance with the disclosure. The method presented in FIG. 6 and described below is intended to be illustrative and non-limiting. The particular series of processing steps depicted in FIG. 6 is not intended to be limiting. It is appreciated that the processing steps may be performed in an order different from that depicted in FIG. 6 and that not all the steps depicted in FIG. 6 need be performed.

In some embodiments, the method depicted in method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At 602, structured data about a set of items in the same category of the target item is obtained. The structured data obtained at 602 can include those data readily indicating one or more features about the items. For example, when the target item is a real-estate property, a house, the set of items may be houses sold within past a few months in the same area as the target house is located. In that example, the structured data for a given house in that set may include last price sold, DOM before last sold, a number of bedrooms, bathrooms, living room, lot size, year built, and any other structured data that can be readily obtained from a real-estate listing website or portal. In some exemplary implementations, operations involved in 602 may be implemented by a data collector the same as or substantially similar to the data collector 2306 described and illustrated herein.

At 604, unstructured data about the set of items in the same category of the target item is obtained. Unstructured data can include those data not readily indicating one or more features about the items. As such, unstructured data needs further processing. One example of unstructured data may include agency data about the houses in the set mentioned above. The agency data may include text description about those houses such as their directions, level of remodeling done, conditions of the houses, materials used for the remodeling, agent remarks, and/or any other unstructured data about the houses. In some exemplary implementations, operations involved in 604 may be implemented by a data collector the same as or substantially similar to the data collector 2306 described and illustrated herein.

At 606, the unstructured data obtained at 604 can proceed. The processing that can be performed at 606 may involve removing some stop words such as “is”, “the” and “as' which don't have distinguishing power in the agency data. The processing may also include generation of nGrams terms that can capture important word like “remodeled”, “repainted” or word chunk like “recent paint”. In some exemplary implementations, operations involved in 606 may be implemented by a data analyzer the same as or substantially similar to the data analyzer 2308 described and illustrated herein.

At 608, a classification model may be trained using the structured and unstructured data. The classification model that can be trained at 2202 can include a logic regression, a random forest, a support vector machine and/or any other suitable classification model. In some exemplary implementations, operations involved in 608 may be implemented by a data analyzer the same as or substantially similar to the data analyzer 2308 described and illustrated herein.

At 610, a regression model can be trained using the obtained structured and unstructured data. In implementations, the regression model that can be trained at 602 can include a random forest and boosting tree. For each item in the set, the list price and actual sold price are known from the structured data, and thus the price difference for the item is known; from the feature engineering performed at 602, 604 and 606, one or more features associated with the item are also known. Using these data, the regression model can be trained to predict a price that can be suggested to a user for bidding for the target item. In some exemplary implementations, operations involved in 610 may be implemented by a data analyzer the same as or substantially similar to the data analyzer 2308 described and illustrated herein.

At 612, DOM can be predicted for the target item using the classification model trained at 608. For example, at 612, a new property can be fed into the classification model to predict DOM for the new property or whether or not the new property would be sold within a certain period of time, e.g., a week. In some exemplary implementations, operations involved in 612 may be implemented by a prediction component the same as or substantially similar to the prediction component 2310 described and illustrated herein.

At 614, a price difference can be predicted for the target item. For example, at 614, the listing price of the target house can be fed into the regression model and a predicted price difference can be determined using the regression model based on the listing price of the target house. The predicted price difference can be a positive or negative value and can be combined with the listing price to obtain a suggested bidding price to a user for bidding on the target house. In some exemplary implementations, operations involved in 614 may be implemented by a prediction component the same as or substantially similar to the prediction component 2310 described and illustrated herein.

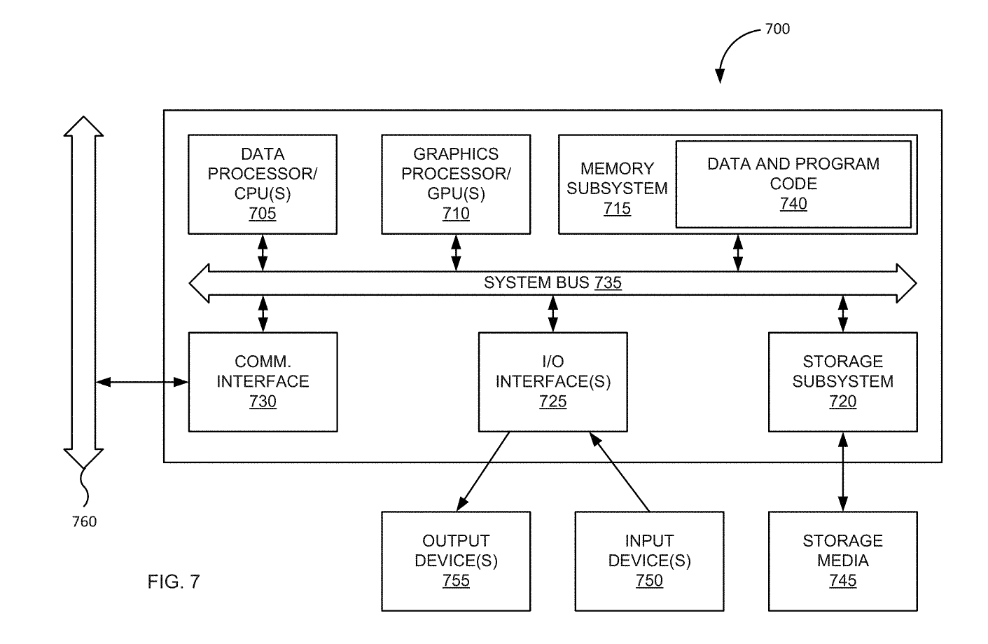

FIG. 7 is a block diagram of computer system 700 that can be used to implement various embodiments described and illustrated herein. FIG. 7 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 700 and any of its components or subsystems can include hardware and/or software elements configured for performing methods described herein.

Computer system 700 may include familiar computer components, such as one or more one or more data processors or central processing units (CPUs) 705, one or more graphics processors or graphical processing units (GPUs) 710, memory subsystem 715, storage subsystem 720, one or more input/output (I/O) interfaces 725, communications interface 730, or the like. Computer system 700 can include system bus 735 interconnecting the above components and providing functionality, such connectivity and inter-device communication.

The one or more data processors or central processing units (CPUs) 705 can execute logic or program code or for providing application-specific functionality. Some examples of CPU(s) 705 can include one or more microprocessors (e.g., single core and multi-core) or micro-controllers, one or more field-gate programmable arrays (FPGAs), and application-specific integrated circuits (ASICs). As used herein, a processor includes a multi-core processor on a same integrated chip, or multiple processing units on a single circuit board or networked.

The one or more graphics processor or graphical processing units (GPUs) 710 can execute logic or program code associated with graphics or for providing graphics-specific functionality. GPUs 710 may include any conventional graphics processing unit, such as those provided by conventional video cards. In various embodiments, GPUs 710 may include one or more vector or parallel processing units. These GPUs may be user programmable, and include hardware elements for encoding/decoding specific types of data (e.g., video data) or for accelerating 2D or 3D drawing operations, texturing operations, shading operations, or the like. The one or more graphics processors or graphical processing units (GPUs) 710 may include any number of registers, logic units, arithmetic units, caches, memory interfaces, or the like.

Memory subsystem 715 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 715 can include data and program code 740.

Storage subsystem 720 can also store information using machine-readable articles, information storage devices, or computer-readable storage media. Storage subsystem 720 may store information using storage media 745. Some examples of storage media 745 used by storage subsystem 720 can include floppy disks, hard disks, optical storage media such as CD-ROMS, DVDs and bar codes, removable storage devices, networked storage devices, or the like. In some embodiments, all or part of data and program code 740 may be stored using storage subsystem 720.

The one or more input/output (I/O) interfaces 725 can perform I/O operations. One or more input devices 750 and/or one or more output devices 755 may be communicatively coupled to the one or more I/O interfaces 725. The one or more input devices 750 can receive information from one or more sources for computer system 700. Some examples of the one or more input devices 750 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 750 may allow a user of computer system 700 to interact with one or more non-graphical or graphical user interfaces to enter a comment, select objects, icons, text, user interface widgets, or other user interface elements that appear on a monitor/display device via a command, a click of a button, or the like.

The one or more output devices 755 can output information to one or more destinations for computer system 700. Some examples of the one or more output devices 755 can include a printer, a fax, a feedback device for a mouse or joystick, external storage systems, a monitor or other display device, a communications interface appropriately configured as a transceiver, or the like. The one or more output devices 755 may allow a user of computer system 700 to view objects, icons, text, user interface widgets, or other user interface elements. A display device or monitor may be used with computer system 700 and can include hardware and/or software elements configured for displaying information.

Communications interface 730 can perform communications operations, including sending and receiving data. Some examples of communications interface 730 may include a network communications interface (e.g. Ethernet, Wi-Fi, etc.). For example, communications interface 730 may be coupled to communications network/external bus 760, such as a computer network, a USB hub, or the like. A computer system can include a plurality of the same components or subsystems, e.g., connected together by communications interface 730 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

Computer system 700 may also include one or more applications (e.g., software components or functions) to be executed by a processor to execute, perform, or otherwise implement techniques disclosed herein. These applications may be embodied as data and program code 740. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 715 and/or storage subsystem 720.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A system for generating a recommendation for suggestion to a user for bidding a target item, the system comprising a processor configured to execute computer programs such that when the computer programs are executed, the system is caused to perform:
obtaining data regarding one or more items in a same category of the target item, wherein the data includes structured data and unstructured data;
processing the data regarding one or more items to extract a set of features for each of the one or more items;
training a regression model using the sets of features extracted for the one or more items;
obtaining data regarding the target item, the data regarding the target item indicating a listing price of the target item; and
predicting a sale price using the listing price of the target item and the regression model.

2. The system of claim 1, wherein processing the data regarding one or more items includes text mining the unstructured data to extract at least one of one or more features.

3. The system of claim 2, wherein the text mining of the unstructured data includes removing one or more stop words in the unstructured data and generating one or more nGrams.

4. The system of claim 2, wherein the text mining of the unstructured data includes using a frequency-inverse document frequency technique to find the at least one feature in unstructured data.

5. The system of claim 1, wherein the regression model includes at least one of a random forest and a boosting tree.

6. The system of claim 1, wherein the sets of features extracted for the one or more items indicate a number of days (DOM) on a market for sale for each of the one or more items, and the method further comprises:
training a classification model using the sets of features extracted for the one or more items; and
predict DOM for the target item using the classification model.

7. The system of claim 1, wherein the classification model includes at least one of a logic regression model, a random forest, and a support vector machine.

8. The system of claim 1, further comprising determining the one or more items are in the same category as the target item by virtue of each of the one or more items is located a same geographic area as the target item.

9. The system of claim 1, wherein the unstructured data includes text description about the one or more items.

10. A method for generating a recommendation for suggestion to a user for bidding a target item, the method being implemented in a processor configured to execute computer programs, the method comprising:
obtaining data regarding one or more items in a same category of the target item, wherein the data includes structured data and unstructured data;
processing the data regarding one or more items to extract a set of features for each of the one or more items;
training a regression model using the sets of features extracted for the one or more items;
obtaining data regarding the target item, the data regarding the target item indicating a listing price of the target item; and
predicting a sale price using the listing price of the target item and the regression model.

11. The method of claim 10, wherein processing the data regarding one or more items includes text mining the unstructured data to extract at least one of one or more features.

12. The method of claim 11, wherein the text mining of the unstructured data includes removing one or more stop words in the unstructured data and generating one or more nGrams.

13. The method of claim 11, wherein the text mining of the unstructured data includes using a frequency-inverse document frequency technique to find the at least one feature in unstructured data.

14. The method of claim 10, wherein the regression model includes at least one of a random forest and a boosting tree.

15. The method of claim 10, wherein the sets of features extracted for the one or more items indicate a number of days (DOM) on a market for sale for each of the one or more items, and the method further comprises:
training a classification model using the sets of features extracted for the one or more items; and
predict DOM for the target item using the classification model.

16. The method of claim 15, wherein the classification model includes at least one of a logic regression model, a random forest, and a support vector machine.

17. The method of claim 10, further comprising determining the one or more items are in the same category as the target item by virtue of each of the one or more items is located a same geographic area as the target item.

18. The method of claim 10, wherein the unstructured data includes text description about the one or more items.
